(19) United States
(12) Patent Application Publication
(10) Pub. No.: US 2024/0340102 A1
(43) Pub. Date: Oct. 10, 2024

(54) LINK RATE SELF-ADAPTION METHOD, AND SYSTEM, DEVICE AND MEDIUM

(71) Applicant: SUZHOU METABRAIN INTELLIGENT TECHNOLOGY CO., LTD., Suzhou (CN)

(72) Inventors: Xun WANG, Suzhou (CN); Jiangbo XU, Suzhou (CN); Wendao MU, Suzhou (CN)

(21) Appl. No.: 18/747,773

(22) Filed: Jun. 19, 2024

Related U.S. Application Data
(63) Continuation of application No. PCT/CN2022/141666, filed on Dec. 23, 2022.

(30) Foreign Application Priority Data
Apr. 26, 2022 (CN) 202210445330.6

(51) Int. Cl. H04L 1/00

(52) U.S. Cl. CPC H04L 1/0003

(57) ABSTRACT

A link-speed self-adapting method includes: creating multiple pairs of a measured-value recording table and a measured-value sequence table at each of nodes; by using a sending node, receiving data frames sent by a receiving node through a reverse link, calculating signal-to-noise ratios of the received data frames, and recording the signal-to-noise ratios and measurement moments into the measured-value recording tables of the sending node; in response to data frames sent by a same sending node and received by the receiving node satisfying a predetermined condition, acquiring the signal-to-noise ratios and the measurement moments corresponding to the data frames that satisfy the predetermined condition, and sending to the sending node by using a message; recording the signal-to-noise ratios and the measurement moments carried in the message into the measured-value sequence table; and according to the measured-value sequence tables, adjusting a speed at which the sending node sends the data frames.

### CROSS REFERENCE TO RELEVANT APPLICATIONS

The present application claims the priority of the Chinese patent application filed on Apr. 26, 2022 before the Chinese Patent Office with the application number of 202210445330.6 and the title of “LINK RATE SELF-ADAPTION METHOD, AND SYSTEM, DEVICE AND MEDIUM”, which is incorporated herein in its entirety by reference.

### FIELD

The present application relates to the technical field of communication, and particularly relates to a link-speed self-adapting method, a link-speed self-adapting system, a device and a non-transitory readable storage medium.

### BACKGROUND

In recent years, with the development of the modern network communication technology, higher requirements on the link quality of wireless communication have been raised. Not only it is required to increase the network throughput, but also the Qos (Quality of Service) of the services should be ensured. However, because the characteristic of fading of wireless communication caused by the time-variation nature and the multipath effect, it presents a time-variation fading characteristic, and has characteristics such as a high bit error rate and a high zero-frame rate. The technique of link self-adaption has been provided to supply an approach of solving that problem. The technique of link self-adaption self-adaptively adjusts the modulation-encoding mode and the code rate according to the variation of the channel quality, to deal with the dynamically varying channel environment, and compensates for the affection by the channel variation on the signal reception.

The study on the technique of link self-adaption has already attained some experience. For example, in the traditional LTE system, how to feed back the current channel quality to the network side is a critical technique of the link self-adaption. All of those techniques require the user to obtain the signal-to-noise ratio (SNR) according to the currently received signal, and subsequently, according to a certain rule, map the SNR to Channel Quality Indicator (CQI) and feed back to the network side. However, when merely the signal-to-noise ratio is used as the inputted parameter, it is easily influenced by multiple factors such as the channel environment and the thermal device noise, and usually has a large difference from the true link environment.

Another example is a link-self-adaption algorithm based on carrier-to-interference ratio (CIR) estimation. The algorithm considers CIR as an indicator that reflects the channel quality, and adjusts the modulation-encoding mode and the code rate according to comparison between the CIR estimation and a conversion-point threshold value. Likewise, the threshold value of the CIR conversion point is closely related to the channel model, but the transmission environment and scene of wireless channels dynamically varies, and is very difficult to preset or estimate in real time.

Accordingly, it can be known that singly relying on CQI or CIR to reflect the channel quality cannot accurately reflect the actual situation of the current channel quality, and is not the optimum strategy for the assessment on the channel environment.

### SUMMARY

In view of the above, in order to overcome the above problems, an embodiment of the present application provides a link-speed self-adapting method, applied to a directional wireless transmission system, and the method includes:
creating a plurality of pairs of a measured-value recording table and a measured-value sequence table at each of a plurality of nodes, wherein each of the pairs of the measured-value recording table and the measured-value sequence table corresponds to one of other nodes;
by using a sending node, receiving data frames sent by a receiving node through a reverse link, calculating signal-to-noise ratios of the received data frames, and recording the signal-to-noise ratios and measurement moments into the measured-value recording tables of the sending node, wherein the sending node is any one of the plurality of nodes, the receiving node is a node, of the plurality of nodes, receiving data frames sent by the sending node through a sending link, and sending the data frames to the sending node through the reverse link, and the measurement moments are moments when the data frames reaches the sending node;
in response to data frames that are sent by a same another node and received by the receiving node satisfying a predetermined condition, acquiring, from the measured-value recording table of the receiving node, the signal-to-noise ratios and the measurement moments corresponding to the data frames that satisfy the predetermined condition, and sending to the sending node by using a message; by the sending node, recording the plurality of signal-to-noise ratios and the plurality of measurement moments that are carried in the message into the measured-value sequence table of the sending node; and
according to the measured-value sequence tables of the sending node, adjusting a speed at which the sending node sends the data frames.

In some embodiments, the measured-value recording table is configured for recording reception-state information of an arriving frame from the corresponding node, and is used to feed back closed-loop measurement information and look up open-loop measurement information.

In some embodiments, the reception-state information of the arriving frame comprises a source-node-identity identifier, a reception signal-to-noise ratio, a reception speed and a measurement moment.

In some embodiments, the measured-value recording table stores by means of a chain table.

In some embodiments, the measured-value sequence table records a closed-loop measurement sample and an open-loop measurement sample that a decision making on speed adjustment requires referring to, the closed-loop measurement sample is obtained by receiving a self-adaption controlling message, and the open-loop measurement sample is obtained by looking up the measured-value recording table.

In some embodiments, when the sending link from the sending node to the receiving node is interrupted, the step of, by using the sending node, receiving the data frames sent by the receiving node through the reverse link, calculating the signal-to-noise ratios of the received data frames, and recording the signal-to-noise ratios and the measurement moments into the measured-value recording tables of the sending node comprises:
by using the sending node, receiving the data frames sent by the receiving node through the reverse link, and calculating the signal-to-noise ratios of the received data frames; and
by using the signal-to-noise ratios of the received data frames as an open-loop measured value, recording the open-loop measured value into the measured-value recording tables of the sending node according to the measurement moments.

In some embodiments, when the sending link from the sending node to the receiving node is not interrupted, the step of, by the sending node, recording the plurality of signal-to-noise ratios and the plurality of measurement moments that are carried in the message into the measured-value sequence table of the sending node comprises:
by using the plurality of signal-to-noise ratios and the plurality of measurement moments that are carried in the message as a closed-loop measured value, storing into the measured-value sequence table of the sending node.

In some embodiments, the measured-value sequence table stores by means of a chain table.

In some embodiments, the predetermined condition is used to determine a quantity of the data frame sent by the sending node.

In some embodiments, the method further comprises:
in response to the message being not received by the sending node at a current measurement moment, from the measured-value recording table of the sending node, according to the current measurement moment, acquiring a plurality of corresponding signal-to-noise ratios and a plurality of measurement moments, and recording into the measured-value sequence table of the sending node.

In some embodiments, the step of, according to the measured-value sequence tables of the sending node, adjusting the speed at which the sending node sends the data frames comprises:
determining a decision-making time interval, wherein a right boundary of the decision-making time interval is a current moment, and a left boundary is decided by a preset length of the decision-making time interval;
according to the decision-making time interval, from the measured-value sequence table of the sending node, acquiring a plurality of signal-to-noise ratios used for decision making; and
according to the plurality of signal-to-noise ratios, adjusting the speed at which the sending node sends the data frames.

In some embodiments, the step of, according to the plurality of signal-to-noise ratios, adjusting the speed at which the sending node sends the data frames comprises:
setting an acceleration-signal-to-noise-ratio threshold and a deceleration-signal-to-noise-ratio threshold; and
among the plurality of signal-to-noise ratios, according to a proportion of the signal-to-noise ratios greater than the acceleration-signal-to-noise-ratio threshold, a proportion of the signal-to-noise ratios less than the deceleration-signal-to-noise-ratio threshold and a proportion of the signal-to-noise ratios between the acceleration-signal-to-noise-ratio threshold and the deceleration-signal-to-noise-ratio threshold, adjusting the speed at which the sending node sends the data frames.

In some embodiments, the step of, among the plurality of signal-to-noise ratios, according to the proportion of the signal-to-noise ratios greater than the acceleration-signal-to-noise-ratio threshold, the proportion of the signal-to-noise ratios less than the deceleration-signal-to-noise-ratio threshold and the proportion of the signal-to-noise ratios between the acceleration-signal-to-noise-ratio threshold and the deceleration-signal-to-noise-ratio threshold, adjusting the speed at which the sending node sends the data frames further comprises:
among the plurality of signal-to-noise ratios, in response to the proportion of the signal-to-noise ratios greater than the acceleration-signal-to-noise-ratio threshold being greater than a preset acceleration-signal-to-noise-ratio-threshold-proportion threshold, performing speed upshifting to the speed at which the sending node sends the data frames;
among the plurality of signal-to-noise ratios, in response to the proportion of the signal-to-noise ratios greater than the acceleration-signal-to-noise-ratio threshold being less than a preset deceleration-signal-to-noise-ratio-threshold-proportion threshold, performing speed downshifting to the speed at which the sending node sends the data frames; and
among the plurality of signal-to-noise ratios, in response to the proportion of the signal-to-noise ratios greater than the acceleration-signal-to-noise-ratio threshold being between the preset acceleration-signal-to-noise-ratio-threshold-proportion threshold and the preset deceleration-signal-to-noise-ratio-threshold-proportion threshold, maintaining the speed at which the sending node sends the data frames.

In some embodiments, speed shifts corresponding to the speed at which the sending node sends the data frames are five shifts.

In some embodiments, the step of adjusting the speed at which the sending node sends the data frames comprises:
adjusting an encoding mode with which the sending node sends the data frames, to adjust the speed at which the sending node sends the data frames.

In some embodiments, the step of setting the acceleration-signal-to-noise-ratio threshold and the deceleration-signal-to-noise-ratio threshold comprises:
according to a current modulation-encoding mode, converting an acceleration-encoding-rate threshold of the current modulation-encoding mode into the acceleration-signal-to-noise-ratio threshold, and converting a deceleration-encoding-rate threshold of the current modulation-encoding mode into the deceleration-signal-to-noise-ratio threshold.

In some embodiments, the encoding mode comprises: binary phase-shift keying, quadrature phase-shift keying modulation, 8 phase-shift keying, 16-symbol quadrature amplitude modulation and 64-symbol quadrature amplitude modulation.

In some embodiments, the message comprises a time parameter of a closed-loop measurement moment, and the method further comprises:
in response to the sending node receives the message sent by the receiving node, according to the time parameter of the closed-loop measurement moment, performing clock recovery.

On the basis of the same inventive concept, according to another aspect of the present application, an embodiment of the present application further provides a link-speed self-adapting system, wherein the system comprises:
a creating module configured for, creating a plurality of pairs of a measured-value recording table and a measured-value sequence table at each of nodes, wherein each of the pairs of the measured-value recording table and the measured-value sequence table corresponds to one of other nodes;
a calculating module configured for, by using a receiving node, receiving data frames sent by a sending node, calculating signal-to-noise ratios of the received data frames, and recording the signal-to-noise ratios and measurement moments into the measured-value recording tables of the receiving node, wherein the receiving node is any one of the plurality of nodes, the sending node is a node, of the plurality of nodes, sending the data frames to the receiving node, and the measurement moments are moments when the data frames reaches the receiving nodes;
a first recording module configured for, in response to data frames that are sent by a same sending node and received by the receiving node satisfying a predetermined condition, acquiring, from the measured-value recording table of the receiving node, the signal-to-noise ratios and the measurement moments corresponding to the data frames that satisfy the predetermined condition, and sending to the sending node by using a message; by the sending node, recording the plurality of signal-to-noise ratios and the plurality of measurement moments that are carried in the message into the measured-value sequence table of the sending node; and
an adjusting module configured for, according to the measured-value sequence tables of the sending node, adjusting a speed at which the sending node sends the data frames.

On the basis of the same inventive concept, an embodiment of the present application further provides a computer device, wherein the computer device comprises:
at least one processor; and
a memory, the memory storing a computer program that is executable in the processor, wherein the processor, when executing the program, implements the steps of the link-speed self-adapting method according to any one of the above embodiments.

On the basis of the same inventive concept, an embodiment of the present application further provides a non-transitory computer-readable storage medium, the non-transitory computer-readable storage medium storing a computer program, wherein the computer program, when executed by a processor, implements the steps of the link-speed self-adapting method according to any one of the above embodiments.

The present application has the following advantageous technical effect. The solutions of the present application, by using the signal-to-noise ratio (SNR) as a reference quantity, dynamically adjust the encoding mode to adjust the speed at which the data frames are sent, whereby the communication links between the nodes employ a more suitable channel-transmission modulation-encoding mode.

### BRIEF DESCRIPTION OF THE DRAWINGS

In order to more clearly illustrate the technical solutions of the embodiments of the present application or the prior art, the figures that are required to describe the embodiments or the prior art will be briefly described below. Apparently, the figures that are described below are merely embodiments of the present application, and a person skilled in the art can obtain other embodiments according to these figures without paying creative work.

FIG. 1 is a schematic flow chart of a link-speed self-adapting method according to an embodiment of the present application;

FIG. 2 is a schematic diagram of a mixed closed-loop and open-loop mechanism according to an embodiment of the present application;

FIG. 3 is a schematic flow chart of open-loop measurement according to an embodiment of the present application;

FIG. 4 is a schematic flow chart of closed-loop measurement according to an embodiment of the present application;

FIG. 5 is a schematic diagram of a speed-self-adaption decision-making mechanism according to an embodiment of the present application;

FIG. 6 is a schematic structural diagram of a link-speed self-adapting system according to an embodiment of the present application;

FIG. 7 is a schematic structural diagram of a computer device according to an embodiment of the present application; and

FIG. 8 is a schematic structural diagram of a non-transitory computer-readable storage medium according to an embodiment of the present application.

### DETAILED DESCRIPTION

In order to make the objects, the technical solutions and the advantages of the present application clearer, the embodiments of the present application will be described in further detail with reference to the particular embodiments and the drawings.

It should be noted that all of the expressions reciting “first” and “second” in the embodiments of the present application are intended to distinguish two different entities or different parameters that have the same names. It can be seen that “first” and “second” are merely for the convenience of the expression, and should not be construed as a limitation on the embodiments of the present application, which will not be explained in detail in the subsequent embodiments.

In the embodiments of the present application, the sending node is the subject that executes the speed self-adaption, and it decides and adjusts the shift of the sending speed to the receiving node.

The receiving node assists the sending node in realizing the function of speed self-adaption, receives the frames from the sending node, and feeds back closed-loop measurement information to the sending node.

The sending link refers to a unidirectional link from the sending node to the receiving node. Via the sending link, the sending node transmits the frames to the receiving node. As the object of the speed self-adaption, the speed self-adaption refers to self-adaptively adjusting the transmission speed in the sending link.

The reverse link refers to a unidirectional link from the receiving node to the sending node. Via the reverse link, the receiving node transmits the frames to the sending node, to assist in the speed self-adaption in the sending link.

The function of speed self-adaption between Node A and Node B: the function comprises both of the speed self-adaption of the sending link Ltx(A, B) from Node A to Node B and the speed self-adaption of the sending link Ltx(B, A) from Node B to Node A. Node A serves as both of the sending node of Ltx(A, B) and the receiving node of Ltx(B, A), and its link self-adapting module comprises both of the function of the self-adaption subject of the sending node and the function of the self-adaption assistance of the receiving node.
Qos: Quality of Service.
SNR: Signal Noise Ratio, or signal-to-noise ratio.
CIR: Carrier to Interference Ratio.
BPSK: Binary Phase Shift Keying.
QPSK: Quadrature Phase Shift Keying, or quadrature phase-shift keying modulation.
8PSK: 8 Phase Shift Keying.
16QAM: 16-symbol Quadrature Amplitude Modulation.
64QAM: 64-symbol Quadrature Amplitude Modulation.

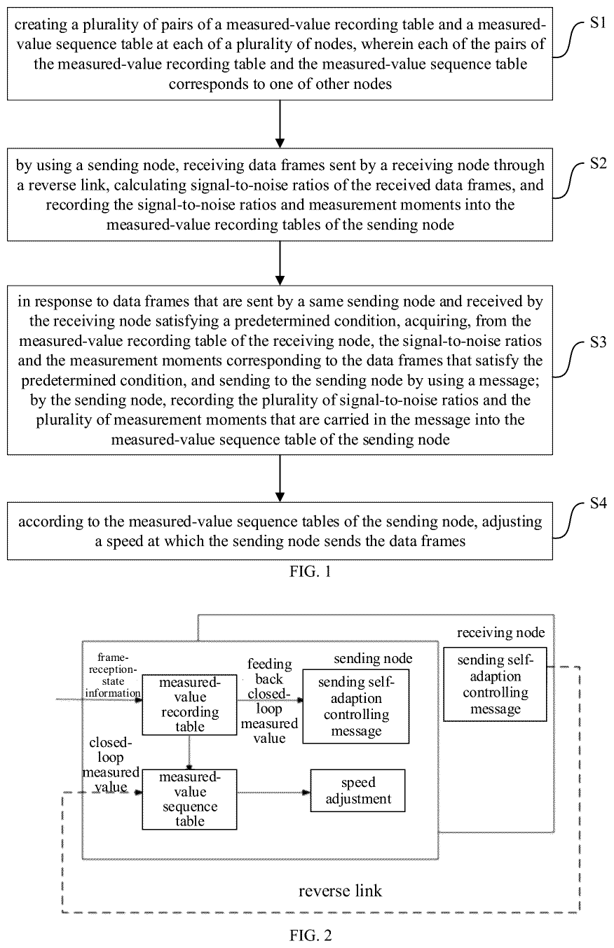

According to an aspect of the present application, an embodiment of the present application provides a link-speed self-adapting method applied to a directional wireless transmission system. As shown in FIG. 1, it may comprise the following steps:
S1: creating a plurality of pairs of a measured-value recording table and a measured-value sequence table at each of a plurality of nodes, wherein each of the pairs of the measured-value recording table and the measured-value sequence table corresponds to one of other nodes;
S2: by using a sending node, receiving data frames sent by a receiving node through a reverse link, calculating signal-to-noise ratios of the received data frames, and recording the signal-to-noise ratios and measurement moments into the measured-value recording tables of the sending node, wherein the sending node is any one of the plurality of nodes, the receiving node is a node, of the plurality of nodes, receiving data frames sent by the sending node through a sending link, and sending the data frames to the sending node through the reverse link, and the measurement moments are moments when the data frames reaches the sending node;
S3: in response to data frames that are sent by a same sending node and received by the receiving node satisfying a predetermined condition, acquiring, from the measured-value recording table of the receiving node, the signal-to-noise ratios and the measurement moments corresponding to the data frames that satisfy the predetermined condition, and sending to the sending node by using a message; by the sending node, recording the plurality of signal-to-noise ratios and the plurality of measurement moments that are carried in the message into the measured-value sequence table of the sending node; and
S4: according to the measured-value sequence tables of the sending node, adjusting a speed at which the sending node sends the data frames.

The solutions of the present application, by using the signal-to-noise ratio (SNR) as a reference quantity, dynamically adjust the encoding mode to adjust the speed at which the data frames are sent, whereby the communication links between the nodes employ a more suitable channel-transmission modulation-encoding mode.

In some embodiments, the method further comprises:
in response to the message being not received by the sending node at a current measurement moment, from the measured-value recording table of the sending node, according to the current measurement moment, acquiring a plurality of corresponding signal-to-noise ratios and a plurality of measurement moments, and recording into the measured-value sequence table of the sending node.

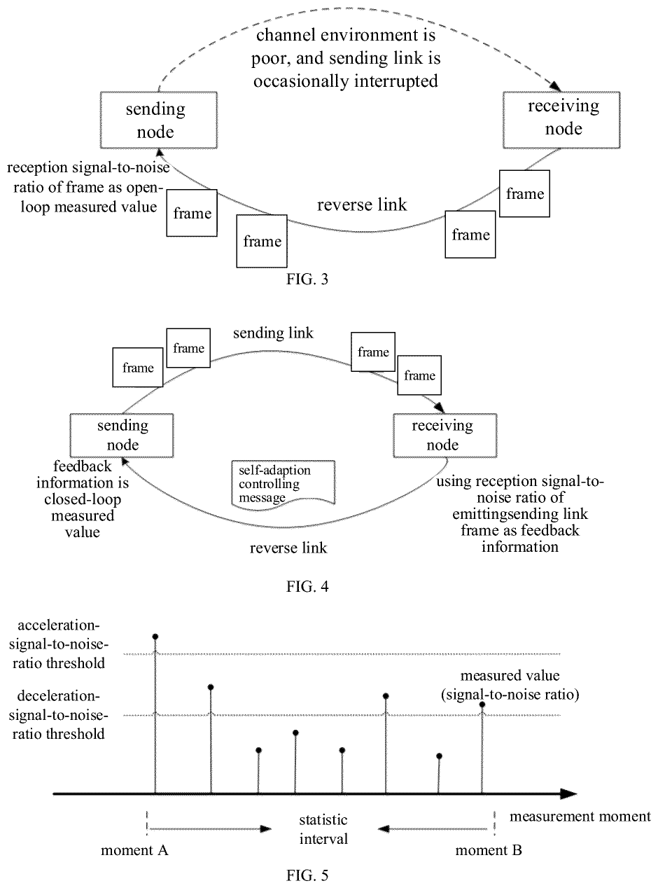

In some embodiments, the dynamically link self-adaption is performed by using a mixed measuring method in which the closed-loop measurement is primary and the open-loop measurement is auxiliary. The adjustment of the node sending speed is based on the closed-loop (the closed-loop measurement method may be seen in FIG. 4 in detail) and open-loop (the open-loop measurement method may be seen in FIG. 3 in detail) measured values of the sending link. Among them, the closed-loop measured value is preferentially used, and the open-loop measured value is used when there is no closed-loop measured value. The link self-adapting module records the arriving-frame reception-state information (including the source node ID (Identity Document, or identity identifier), the receiving SNR, the reception speed, and the moment) from the link layer, as the open-loop measurement information of the sending link of the present node. The link self-adapting module periodically feeds back according to the above-described frame-reception state, and the method includes transmitting a self-adaption controlling message to the receiving node by using a link-layer function block, and parsing and extracting the information by using an opposite-terminal link self-adapting module, to be used as the closed-loop measurement information of the sending link of the frame sending link, which may be seen in detail in the mixed closed-loop and open-loop measurement mechanism shown in FIG. 2.

As shown in FIG. 2, the receiving node in the figure serves as the sending side, and the sending node serves as the receiving side. Therefore, because actually all of the nodes have the full-stack function, and have equal statuses, the corresponding sending node also periodically sends a self-adaption controlling message to the receiving node.

In an ideal situation in which all of the frames in the sending link and the reverse link are transmitted correctly, the sending node, within each of the periods, receives at least one self-adaption controlling message from the receiving node. Accordingly, in the ideal situation, assuming that the receiving node sends a frame including the self-adaption controlling message by using the same time slot in each of the frames, the measured-value sequence table of the sending node is, within each of the periods, added at least one closed-loop measurement sample (the quantity of the added sample is decided by the predetermined condition of the step S3, or, in other words, the predetermined condition decides how many signal-to-noise ratios the message includes), and one sample is the signal-to-noise ratio corresponding to one data frame.

However, in a practical channel environment, the transmission of wireless frames might fail, which causes that the measured-value sequence table is not added a new closed-loop measurement sample within one period. In this case, as shown in FIG. 2, the sending node looks up a local measured-value recording table to obtain the open-loop measured value within that period, and, as an open-loop measured-value sample, adds into the measured-value sequence table.

In some embodiments, in the Step S2 of, by using thesending node, receiving the data frames sent by the receiving node through the reverse link, calculating the signal-to-noise ratios of the received data frames, and recording the signal-to-noise ratios and the measurement moments into the measured-value recording tables, as shown in FIG. 3, the open-loop measurement is based on the assumption that the states of the sending link and the reverse link are the same. The object of the open-loop measurement by the sending node on the sending link is the frames transmitted in the reverse link, and the sending node measures to obtain the reception signal-to-noise ratio of the frames to be used as the open-loop measured value. In other words, the signal-to-noise ratio of the data frame received by each of the nodes is used as the open-loop measured value, and recorded into the measured-value recording table. The measured-value recording table records the reception information of the arriving frame, and is used to feed back the closed-loop measurement information and look up the open-loop measurement information.

In some embodiments, the measured-value recording table is mainly used to record the reception-state information (the reception speed, the reception signal-to-noise ratio and the measurement moment) of the arriving frame from the source node i, among them, the reception speed refers to the sending speed of the arriving frame, and is used to calculate the bit error rate, the reception signal-to-noise ratio refers to the signal-to-noise ratio that is obtained by measuring the arriving frame, and is used as the measured value of the sending link, and the measurement moment refers to the moment at which the frame arrives, and is used as the measurement moment. The link self-adapting module, except for the present node h, is required to maintain one measured-value recording table for each of the nodes in the network. Regarding an arriving frame from a certain node i, the measured-value recording table corresponding to the node i records its reception-state information, and is used to feed back its closed-loop measured value to the node i and look up the open-loop measured value of the present node h. The table is stored by means of a chain table, and when a measurement moment is later, it is closer to the table header.

In some embodiments, in the Step S3 of, in response to the data frames that are sent by the same sending node and received by the receiving node satisfying the predetermined condition, from the measured-value recording table of the receiving node, acquiring the signal-to-noise ratios and the measurement moments corresponding to the data frames that satisfy the predetermined condition, and sending to the sending node by using the message, whereby the sending node records the plurality of signal-to-noise ratios and the plurality of measurement moments that are carried in the message into the measured-value sequence table of the sending node. In some embodiments, as shown in FIG. 4, the object of the closed-loop measurement by the sending node on the sending link is the transmitted frame in the sending link, and the reception signal-to-noise ratio is obtained by measuring by the receiving node, subsequently fed back via the reverse link and the message to the sending node as the closed-loop measured value, and stored into the measured-value sequence table. The measured-value sequence table records the closed-loop measurement samples and the open-loop measurement samples that the decision making on the speed adjustment requires referring to, among them, the closed-loop measurement sample is obtained by receiving the self-adaption controlling message, and the open-loop measurement sample is obtained by looking up the measured-value recording table.

In some embodiments, the measured-value sequence table is used to observe the samples of the mixed closed-loop and open-loop measurement of the sending link Ltx(h, i), the link self-adapting module maintains one measured-value sequence table for each of the nodes i in the network except for the present node h, the table records the measurement type (used to identify the measurement type of the sample), the speed (which, when the measurement type of the sample is closed loop, represents the sending speed of h, and when it is open loop, represents the reception speed of h (i.e., the sending speed of i)), the signal-to-noise ratio (the measured value of the signal-to-noise ratio of the sample, which, when the measurement type of the sample is closed loop, characterizes the measured value of the closed-loop signal-to-noise ratio (the measurement on Ltx(h, i)), and when it is open loop, characterizes the measured value of the open-loop reception signal-to-noise ratio (the measurement on Ltx(i, h))), and the measurement moment (the moment at which the frame arrives, and used as the measurement moment, which, when the measurement type of the sample is closed loop, is the frame arrival moment recorded at the node i, and when it is open loop, is the frame arrival moment recorded at the node h). Regarding a certain node i, its measured-value sequence records the closed-loop and open-loop measurement samples for the sending link Ltx(h, i), to be used for the self-adaption decision making, and each of the item lines corresponds to one measurement sample. The sequence is stored by means of a chain table, and the samples in the sequence are ordered according to the measurement moments in the attribute, when the measurement moment is later (the sample is newer), it is closer to the head of the chain table.

By comparing the closed-loop measured value and the open-loop measured value, it can be seen that the closed-loop measured value can obviously indicate the link state more accurately, but it relies on the correct information transmission and feeding-back in the reverse link. The open-loop measured value is easier to obtain, but it accuracy is inferior to that of the closed-loop measured value. Therefore, the speed self-adaption employs a mixed method in which the closed-loop measured value is primary and the open-loop measured value is auxiliary, to improve the adaptability of the nodes in severe channel environments.

In other words, the realizing of a speed-self-adaption mechanism which mixes closed loop and open loop mainly relies on the measured-value recording table, the measured-value sequence table and the self-adaption controlling message. The open-loop measured value and the closed-loop measured value are acquired based on the measured-value recording table and the self-adaption controlling message respectively, and the link self-adaption decision making is based on the measured-value sequence table which mixes the closed-loop measured value and the open-loop measured value. Moreover, from the perspective of the internal nodes in the network, sending and receiving are in fact relative concepts, and the sending speed and the closed-loop signal-to-noise ratio in the message data are in fact the reception speed and the reception signal-to-noise ratio in the measured-value recording table of the receiving node.

In some embodiments, regarding a certain sending link, the measurement information is taken out by the receiving node (relative to the sending link) from the measured-value recording table of the receiving node within the latest period, the measurement information (i.e., the frame-reception state) includes the reception speed, the reception signal-to-noise ratio and the measurement moment), which is fed back to the sending node as the closed-loop measurement information. In addition, regarding the closed-loop measurement moment, when the clocks of the sending node and the receiving node are synchronous, the difference between the frame arrival moment (the closed-loop measurement moment) recorded by the receiving node and the moment when the sending node receives the link self-adapting message does not exceed the second level. Therefore, in order to reduce the message length, the message value includes the time parameter of the closed-loop measurement moment (for example, the time-slot number and the second number), and the sending node performs clock recovery by referring to the local system after the message is received.

The self-adaption controlling message may include a message type, a message ID, an item quantity and a first-item second number. The message type is the closed-loop measurement information. The message ID is used to identify the self-adaption controlling message. The item quantity is the quantity of the items of the closed-loop measurement information included in the self-adaption controlling message. The first-item second number corresponds to the closed-loop measurement moment of the first item, and represents its second number, and the measurement moment is obtained by calculation by referring to the time-slot number in the item and the current system time.

In some embodiments, the step of, according to the measured-value sequence tables of the sending node, adjusting the speed at which the sending node sends the data frames comprises:
determining a decision-making time interval, wherein a right boundary of the decision-making time interval is a current moment, and a left boundary is decided by a preset length of the decision-making time interval;
according to the decision-making time interval, from the measured-value sequence table of the sending node, acquiring a plurality of signal-to-noise ratios used for decision making; and
according to the plurality of signal-to-noise ratios, adjusting the speed at which the sending node sends the data frames.

In some embodiments, the step of, according to the plurality of signal-to-noise ratios, adjusting the speed at which the sending node sends the data frames further comprises:
setting an acceleration-signal-to-noise-ratio threshold and a deceleration-signal-to-noise-ratio threshold; and
among the plurality of signal-to-noise ratios, according to a proportion of the signal-to-noise ratios greater than the acceleration-signal-to-noise-ratio threshold, a proportion of the signal-to-noise ratios less than the deceleration-signal-to-noise-ratio threshold and a proportion of the signal-to-noise ratios between the acceleration-signal-to-noise-ratio threshold and the deceleration-signal-to-noise-ratio threshold, adjusting the speed at which the sending node sends the data frames.

In some embodiments, in the situation in which the sending node continuously obtains the measured value of the sending link approximately in real time, the shift of the sending speed should match with the state of the sending link. In order to facilitate to comprehend the solutions of the present application, bPSK, QPSK, 8PSK, 16QAM and 64QAM may be defined as 5 shifts of 1, 2, 3, 4 and 5 respectively. When the channel environment is poor, and the link measurement situation is poor, the state of the sending link is poor, and the shift of the sending speed should be reduced (till it is at the lowest shift), to use a low-order encoding mode (for example, BPSK), so as to compromise part of the channel loading capacity, and ensure that the link is not interrupted. When the state of the sending link is good, the shift of the sending speed should be increased (till it is at the highest shift), to use a high-order encoding mode (for example, 64QAM), so as to maximize the system loading capacity. Accordingly, when the channel environment is good, the system loading capacity is maximized, and when the channel environment is poor, the link state is maintained at the connection state to the largest extent.

As shown in FIG. 5, within the time interval of the decision-making counting-up, the measured values are formed by mixing the closed-loop measured values and the open-loop measured values, and are distributed in the whole interval evenly. Furthermore, according to the current modulation-encoding mode, the acceleration-encoding-rate threshold and the deceleration-encoding-rate threshold may be converted into the acceleration-signal-to-noise-ratio threshold and the deceleration-signal-to-noise-ratio threshold. Subsequently, by using the measured-value sequence table, the measured values of the signal-to-noise ratio within one time interval (moment A, moment B) are acquired, to perform comparison and counting-up, to obtain the proportions of the quantities of the measured values greater than the acceleration-signal-to-noise-ratio threshold and the measured values less than deceleration-signal-to-noise-ratio threshold in the total quantity of all of the measured values within the time interval.

When the proportion of the signal-to-noise ratios greater than the acceleration-signal-to-noise-ratio threshold is greater than the acceleration-signal-to-noise-ratio-threshold-proportion threshold, then speed upshifting is performed. When the proportion of the signal-to-noise ratios greater than the acceleration-signal-to-noise-ratio threshold is less than the deceleration-signal-to-noise-ratio-threshold-proportion threshold, then speed downshifting is performed. When the proportion of the signal-to-noise ratios greater than the acceleration-signal-to-noise-ratio threshold is between the two threshold-proportion thresholds, then the speed shift maintains unchanged.

The time interval (moment A, moment B) of the decision-making counting-up should use the current moment of the decision making as the right boundary. It should be noted that the time interval should not be excessively short, or else the emission speed oscillates frequently, which causes that the dynamic time-slot adjustment has an excessively high requirement on the response time, and is influenced by sudden changes of the link state. Furthermore, the time interval should not be excessively long, or else the speed self-adaption senses the variation of the link state insensitively, which causes that the speed decision making is not in time and accurate.

The technical solutions of the present application, by using the signal-to-noise ratio (SNR) as a reference quantity, based on the closed-loop measured value and the open-loop measured value of the sending link (an unidirectional link in which the node is used for emission), dynamically adjust the encoding mode to solve the problem of link self-adaption, and use the mixed measuring method in which the closed-loop measurement is primary and the open-loop measurement is auxiliary to perform the determination on acceleration or deceleration, whereby the communication links between the nodes employ a more suitable channel-transmission modulation-encoding mode approximately in real time.

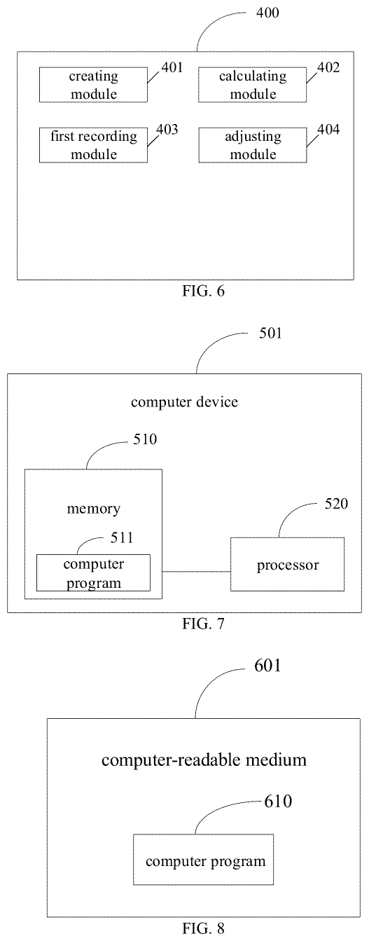

On the basis of the same inventive concept, according to another aspect of the present application, an embodiment of the present application further provides a link-speed self-adapting system 400. As shown in FIG. 6, the system comprises:
a creating module 401 configured for, creating a plurality of pairs of a measured-value recording table and a measured-value sequence table at each of nodes, wherein each of the pairs of the measured-value recording table and the measured-value sequence table corresponds to one of other nodes;
a calculating module 402 configured for, by using a sending node, receiving data frames sent by a receiving node through a reverse link, calculating signal-to-noise ratios of the received data frames, and recording the signal-to-noise ratios and measurement moments into the measured-value recording tables of the sending node;
a first recording module 403 configured for, in response to data frames that are sent by a same sending node and received by the receiving node satisfying a predetermined condition, from the measured-value recording table of the receiving node, acquiring the signal-to-noise ratios and the measurement moments corresponding to the data frames that satisfy the predetermined condition, and sending to the sending node by using a message, by using the sending node, recording the plurality of signal-to-noise ratios and the plurality of measurement moments that are carried in the message into the measured-value sequence table of the sending node; and
an adjusting module 404 configured for, according to the measured-value sequence tables of the sending node, adjusting a speed at which the sending node sends the data frames.

In some embodiments, the system further comprises a second recording module configured for:
in response to the message being not received by the sending node at a current measurement moment, from the measured-value recording table of the sending node, according to the current measurement moment, acquiring a plurality of corresponding signal-to-noise ratios and a plurality of measurement moments, and recording into the measured-value sequence table of the sending node.

In some embodiments, the adjusting module 404 is further configured for:
determining a decision-making time interval, wherein a right boundary of the decision-making time interval is a current moment, and a left boundary is decided by a preset length of the decision-making time interval;
according to the decision-making time interval, from the measured-value sequence table of the sending node, acquiring a plurality of signal-to-noise ratios used for decision making; and
according to the plurality of signal-to-noise ratios, adjusting the speed at which the sending node sends the data frames.

In some embodiments, the adjusting module 404 is further configured for:
setting an acceleration-signal-to-noise-ratio threshold and a deceleration-signal-to-noise-ratio threshold; and
among the plurality of signal-to-noise ratios, according to a proportion of the signal-to-noise ratios greater than the acceleration-signal-to-noise-ratio threshold, a proportion of the signal-to-noise ratios less than the deceleration-signal-to-noise-ratio threshold and a proportion of the signal-to-noise ratios between the acceleration-signal-to-noise-ratio threshold and the deceleration-signal-to-noise-ratio threshold, adjusting the speed at which the node sends the data frames.

On the basis of the same inventive concept, according to another aspect of the present application, as shown in FIG. 7, an embodiment of the present application further provides a computer device 501, wherein the computer device 501 comprises:
at least one processor 520; and
a memory 510, the memory 510 storing a computer program 511 that is executable in the processor, wherein the processor 520, when executing the program, implements the steps of the link-speed self-adapting method according to any one of the above embodiments.

On the basis of the same inventive concept, according to another aspect of the present application, as shown in FIG. 8, an embodiment of the present application further provides a non-transitory computer-readable storage medium 601, the non-transitory computer-readable storage medium 601 storing a computer program 610, wherein the computer program 610, when executed by a processor, implements the steps of the link-speed self-adapting method according to any one of the above embodiments.

Finally, it should be noted that a person skilled in the art can understand that all or some of the processes of the methods according to the above embodiments may be implemented by relative hardware according to an instruction from a computer program, the program may be stored in a non-transitory computer-readable storage medium, and the program, when executed, may contain the processes of the embodiments of the method stated above.

Furthermore, it should be noted that the non-transitory computer-readable storage medium (for example, a memory) as used herein may be a volatile memory or a non-transitory memory, or may comprise both of a volatile memory and a non-transitory memory.

A person skilled in the art should also understand that various illustrative logical blocks, modules, electric circuits and algorithm steps described with reference to the disclosure herein may be embodied as electronic hardware, computer software or a combination thereof. In order to clearly explain the interchangeability between the hardware and the software, it has been described generally with reference to the functions of various illustrative components, blocks, modules, electric circuits and steps. Whether those functions are embodied as software or hardware depends on the particular applications and the design constraints exerted on the entire system. A person skilled in the art may employ different modes to implement the functions with respect to each of the particular applications, but those implementation decisions should not be considered as leading to departing from the scope disclosed by the embodiments of the present application.

The illustrative embodiments disclosed by the present application are described above. However, it should be noted that many variations and modifications may be made without departing from the scope of the embodiments of the present application defined by the claims. The functions, steps and/or acts of the process claims according to the disclosed embodiments described herein are not required to be implemented in any specific sequence. Furthermore, although the elements of the embodiments of the present application may be described or claimed in a singular form, unless explicitly limited as singular, they may also be comprehended as plural.

It should be understood that, as used herein, unless the context clearly supports an exception, the singular form “a” is intended to encompass a plural form. It should also be understood that, as used herein, the “and/or” refers to including any and all feasible combinations of one or more relatively listed items.

The serial numbers of the embodiments of the present application are merely for the purpose of description, and do not indicate the relative preferences of the embodiments.

A person skilled in the art can understand that all or some of the steps for implementing the above embodiments may be completed by hardware, and may also be completed by using a program to instruct relevant hardware. The program may be stored in a non-transitory computer-readable storage medium. The above-mentioned non-transitory readable storage medium may be a read-only memory, a magnetic disk, an optical disk and so on.

A person skilled in the art should understand that the discussion on any of the above embodiments is merely illustrative, and are not intended to imply that the scope (including the claims) of the embodiments of the present application is limited to those examples. With the concept of the embodiments of the present application, the embodiments or the technical features of different embodiments may be combined, and many other variations of different aspects of the embodiments of the present application as stated above may exist, which are not provided in detail for brevity. Therefore, any omissions, modifications, equivalent substitutions and improvements that are made within the spirit and the principle of the embodiments of the present application should fall within the protection scope of the embodiments of the present application.

1. A link-speed self-adapting method, applied to a directional wireless transmission system, wherein the method comprises:
creating a plurality of pairs of a measured-value recording table and a measured-value sequence table at each of a plurality of nodes, wherein each of the pairs of the measured-value recording table and the measured-value sequence table corresponds to one of other nodes;
by using a sending node, receiving data frames sent by a receiving node through a reverse link, calculating signal-to-noise ratios of the received data frames, and recording the signal-to-noise ratios and measurement moments into the measured-value recording tables of the sending node, wherein the sending node is any one of the plurality of nodes, the receiving node is a node, of the plurality of nodes, receiving data frames sent by the sending node through a sending link, and sending the data frames to the sending node through the reverse link, and the measurement moments are moments when the data frames reaches the sending node;
in response to data frames that are sent by a same sending node and received by the receiving node satisfying a predetermined condition, acquiring, from the measured-value recording table of the receiving node, the signal-to-noise ratios and the measurement moments corresponding to the data frames that satisfy the predetermined condition, and sending to the sending node by using a message; by the sending node, recording the plurality of signal-to-noise ratios and the plurality of measurement moments that are carried in the message into the measured-value sequence table of the sending node; and
according to the measured-value sequence tables of the sending node, adjusting a speed at which the sending node sends the data frames.

2. The method according to claim 1, wherein the measured-value recording table is configured for recording reception-state information of an arriving frame from the corresponding node, and is used to feed back closed-loop measurement information and look up open-loop measurement information.

3. The method according to claim 2, wherein the reception-state information of the arriving frame comprises a source-node-identity identifier, a reception signal-to-noise ratio, a reception speed and a measurement moment.

4. The method according to claim 1, wherein the measured-value recording table stores by means of a chain table.

5. The method according to claim 1, wherein the measured-value sequence table records a closed-loop measurement sample and an open-loop measurement sample that a decision making on speed adjustment requires referring to, the closed-loop measurement sample is obtained by receiving a self-adaption controlling message, and the open-loop measurement sample is obtained by looking up the measured-value recording table.

6. The method according to claim 1, wherein when the sending link from the sending node to the receiving node is interrupted, the step of, by using the sending node, receiving the data frames sent by the receiving node through the reverse link, calculating the signal-to-noise ratios of the received data frames, and recording the signal-to-noise ratios and the measurement moments into the measured-value recording tables of the sending node comprises:
by using the sending node, receiving the data frames sent by the receiving node through the reverse link, and calculating the signal-to-noise ratios of the received data frames; and
by using the signal-to-noise ratios of the received data frames as an open-loop measured value, recording the open-loop measured value into the measured-value recording tables of the sending node according to the measurement moments.

7. The method according to claim 1, wherein when the sending link from the sending node to the receiving node is not interrupted, the step of, by the sending node, recording the plurality of signal-to-noise ratios and the plurality of measurement moments that are carried in the message into the measured-value sequence table of the sending node comprises:
by using the plurality of signal-to-noise ratios and the plurality of measurement moments that are carried in the message as a closed-loop measured value, storing into the measured-value sequence table of the sending node.

8. The method according to claim 1, wherein the measured-value sequence table stores by means of a chain table.

9. The method according to claim 1, wherein the predetermined condition is used to determine a quantity of the data frame sent by the sending node.

10. The method according to claim 1, wherein the method further comprises:
in response to the message being not received by the sending node at a current measurement moment, from the measured-value recording table of the sending node, according to the current measurement moment, acquiring a plurality of corresponding signal-to-noise ratios and a plurality of measurement moments, and recording into the measured-value sequence table of the sending node.

11. The method according to claim 1, wherein the step of, according to the measured-value sequence tables of the sending node, adjusting the speed at which the sending node sends the data frames comprises:
determining a decision-making time interval, wherein a right boundary of the decision-making time interval is a current moment, and a left boundary is decided by a preset length of the decision-making time interval;
according to the decision-making time interval, from the measured-value sequence table of the sending node, acquiring a plurality of signal-to-noise ratios used for decision making; and
according to the plurality of signal-to-noise ratios, adjusting the speed at which the sending node sends the data frames.

12. The method according to claim 11, wherein the step of, according to the plurality of signal-to-noise ratios, adjusting the speed at which the sending node sends the data frames comprises:
setting an acceleration-signal-to-noise-ratio threshold and a deceleration-signal-to-noise-ratio threshold; and
among the plurality of signal-to-noise ratios, according to a proportion of the signal-to-noise ratios greater than the acceleration-signal-to-noise-ratio threshold, a proportion of the signal-to-noise ratios less than the deceleration-signal-to-noise-ratio threshold and a proportion of the signal-to-noise ratios between the acceleration-signal-to-noise-ratio threshold and the deceleration-signal-to-noise-ratio threshold, adjusting the speed at which the sending node sends the data frames.

13. The method according to claim 12, wherein the step of, among the plurality of signal-to-noise ratios, according to the proportion of the signal-to-noise ratios greater than the acceleration-signal-to-noise-ratio threshold, the proportion of the signal-to-noise ratios less than the deceleration-signal-to-noise-ratio threshold and the proportion of the signal-to-noise ratios between the acceleration-signal-to-noise-ratio threshold and the deceleration-signal-to-noise-ratio threshold, adjusting the speed at which the sending node sends the data frames further comprises:
among the plurality of signal-to-noise ratios, in response to the proportion of the signal-to-noise ratios greater than the acceleration-signal-to-noise-ratio threshold being greater than a preset acceleration-signal-to-noise-ratio-threshold-proportion threshold, performing speed upshifting to the speed at which the sending node sends the data frames;
among the plurality of signal-to-noise ratios, in response to the proportion of the signal-to-noise ratios greater than the acceleration-signal-to-noise-ratio threshold being less than a preset deceleration-signal-to-noise-ratio-threshold-proportion threshold, performing speed downshifting to the speed at which the sending node sends the data frames; and
among the plurality of signal-to-noise ratios, in response to the proportion of the signal-to-noise ratios greater than the acceleration-signal-to-noise-ratio threshold being between the preset acceleration-signal-to-noise-ratio-threshold-proportion threshold and the preset deceleration-signal-to-noise-ratio-threshold-proportion threshold, maintaining the speed at which the sending node sends the data frames.

14. The method according to claim 13, wherein speed shifts corresponding to the speed at which the sending node sends the data frames are five shifts.

15. The method according to claim 12, wherein the step of adjusting the speed at which the sending node sends the data frames comprises:
adjusting an encoding mode with which the sending node sends the data frames, to adjust the speed at which the sending node sends the data frames.

16. The method according to claim 15, wherein the step of setting the acceleration-signal-to-noise-ratio threshold and the deceleration-signal-to-noise-ratio threshold comprises:
according to a current modulation-encoding mode, converting an acceleration-encoding-rate threshold of the current modulation-encoding mode into the acceleration-signal-to-noise-ratio threshold, and converting a deceleration-encoding-rate threshold of the current modulation-encoding mode into the deceleration-signal-to-noise-ratio threshold.

17. The method according to claim 15, wherein the encoding mode comprises: binary phase-shift keying, quadrature phase-shift keying modulation, 8 phase-shift keying, 16-symbol quadrature amplitude modulation and 64-symbol quadrature amplitude modulation.

18. The method according to claim 1, wherein the message comprises a time parameter of a closed-loop measurement moment, and the method further comprises:
in response to the sending node receives the message sent by the receiving node, according to the time parameter of the closed-loop measurement moment, performing clock recovery.

19. A computer device, wherein the computer device comprises:
at least one processor; and
a memory, the memory storing a computer program that is executable in the processor, wherein the processor, when executing the program, implements the link-speed self-adapting method according to claim 1.

20. A non-transitory computer-readable storage medium, the non-transitory computer-readable storage medium storing a computer program, wherein the computer program, when executed by a processor, implements the link-speed self-adapting method according to claim 1.
